(19) United States
(12) Patent Application Publication
(10) Pub. No.: US 2011/0011040 A1
(43) Pub. Date: Jan. 20, 2011

(54) Equine Chin and Crown Guard

(76) Inventor: Elaine Matern, Pacific Palisades, CA (US)

Correspondence Address: Elaine Matern, #482, 15332 Antioch Street, Pacific Palisades, CA, 90272, US

(21) Appl. No.: 12/504,026

(22) Filed: Jul. 16, 2009

(51) Int. Cl. B68B 1/04

(52) U.S. Cl. 54/6.1

(57) ABSTRACT

A chin and crown guard to be used between horse and the bridle; made to enhance the horse's comfort and protection as well as enhancing the rider's performance.

Made from machine-cut closed-cell chloroprene and styrene-butadiene-rubber (SBR) neoprene, the chin and crown guard cushions and protects the horse's chin and/or crown (top-of-head) from chaffing and discomfort from the bridle. It has a polyester fabric lining on one side (back side) to enhance the horse's comfort. The neoprene rubber is flexible for easy application and it maximizes durability and security for the rider. It is both washable and re-usable.

The chin and crown guard is place between the horse and the bridle under the chin and/or on the crown (top-of-head). The fabric is placed against the horse for comfort.

Each guard is 2¼″ wide×7″ long×8.5-to-9 mm thick.

### BACKGROUND OF THE INVENTION

This invention relates to the a chin and crown guard for horses to improve the comfort of the horse, to protect the horse from bridle chaffing, to improve the rider's experience and the performance of the horse.

This invention is made from the highest quality materials available. Most similar products are made with inferior materials or are fabricated as make-shift rubber solutions.

The object of the present invention is to provide a more durable, comfortable, flexible, secure chin and crown guard that is lightweight, inexpensive, and easy to use.

### SUMMARY OF THE INVENTION

The object of the invention is to improve the comfort and protection and performance of the horse and to improve the rider's experience. It has been designed to overcome the limitations of currently available chin and crown guard options. The invention is made with the highest quality materials available.

Made from machine-cut closed-cell chloroprene (30%) and styrene-butadiene-rubber (SBR) neoprene (70%), the chin and crown guard cushions and protects the horse's chin and/or crown (top-of-head) from chaffing and discomfort from the bridle. It has a polyester fabric lining on one side (back side) to enhance the horse's comfort. The neoprene rubber is flexible for easy application and it maximizes durability and security for the rider. It is both washable and re-usable.

The chin and crown guard is place between the horse and the bridle under the chin and/or on the crown (top-of-head). The fabric is placed against the horse for comfort.

Each guard is 2¼″ wide×7″ long×8.5-to-9mm thick, with the fabric consisting of approximately ½ mm of that total thickness.

Styrene-Butadiene-Rubber (SBR) is a synthetic rubber copolymer consisting of styrene and butadiene. It has good abrasion resistance and good aging stability.

SBR can be produced from solution or as emulsion. In both instances, the reaction is via free radical polymerization. Pressure reaction vessels are required and usually charged with the two monomers, a free radical acid and a chain transfer agent such as an alkyl mercaptan. The latter prevents high molecular weight and high viscosity product from forming. High styrene-content rubbers are hard, since the Tg (glass transition temperature) of butadiene is extremely low. The production process is initiated by sodium.

The chemical structure of SBR is:

Chloroprene is the common name for the organic compound 2-chloro-1,3-butadiene, which has the formula CH2═CCl-CH═CH2. This colorless liquid is the monomer* for the production of the polymer polychloroprene, a type of synthetic rubber. *A monomer is a small molecule that may become chemically bonded to other monomers to form a polymer. The most common natural monomer is glucose, which is linked by glycosidic bonds into polymers such as cellulose and starch, and is over 33% of the weight of all plant matter.

### DESCRIPTION OF DRAWINGS

FIG. 1 is a front and back and side (or thickness) view with notations of composition;

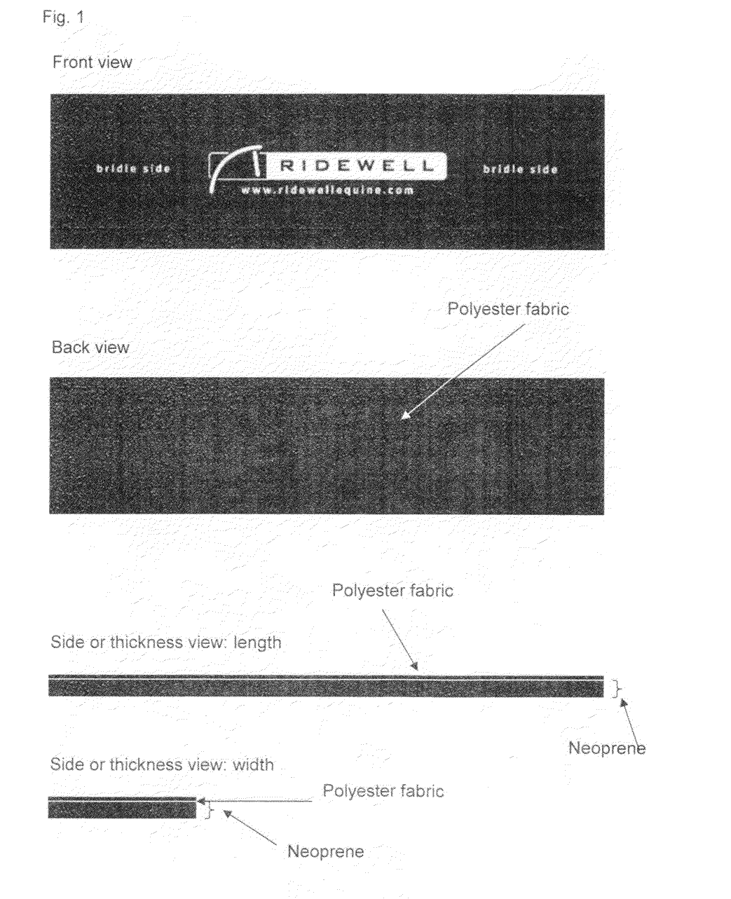

FIG. 2 is a 3-dimensional view with notations of composition;

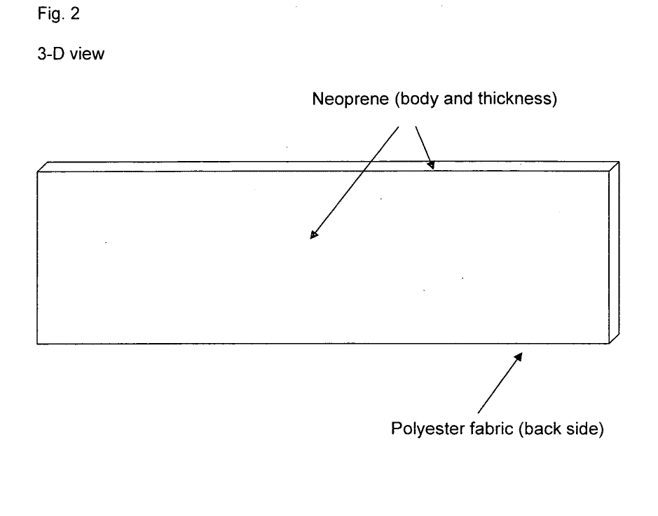

FIG. 3 is a side view with notations of composition;

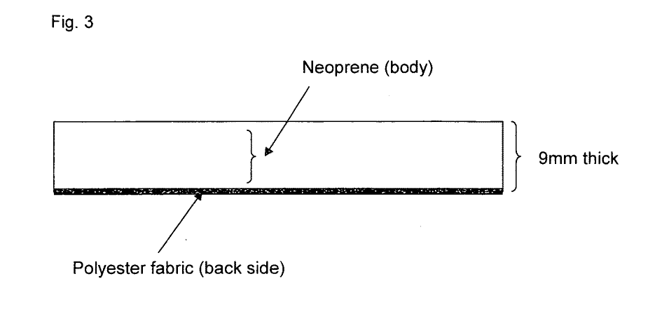

FIG. 4 is an illustration of the invention in use.

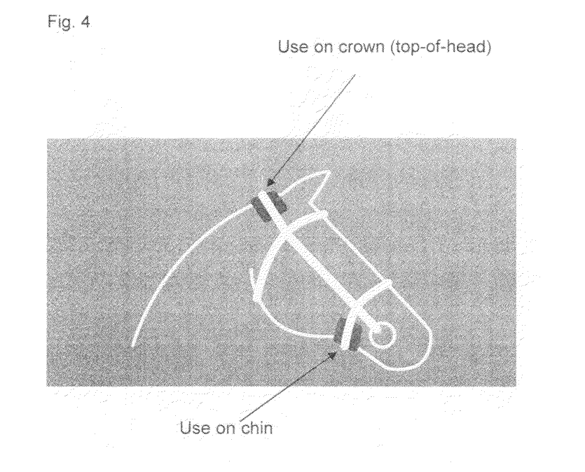

1. A chin and crown guard for horses made from machine-cut closed-cell SBR neoprene rubber with polyester fabric on one side. 2¼″ wide×7″ long×8.5-to-9 mm thick.

2. Made for enhancing the comfort and protection of the horse.

3. Made to be durable and flexible for the rider.

4. Made to improve performance by improving the secure fit of bridle to horse.
